(19) United States
(12) Patent Application Publication
(10) Pub. No.: US 2012/0116575 A1
(43) Pub. Date: May 10, 2012

(54) COMBINATION ELECTRIC VEHICLE CHARGER AND POINT OF SALE DEVICE

(75) Inventors: Ronald D. Prosser, Huntington Beach, CA (US); Victor Shao, Mountain View, CA (US)

(73) Assignee: The Prosser Group LLC, Huntington Beach, CA (US)

(21) Appl. No.: 12/939,394

(22) Filed: Nov. 4, 2010

(51) Int. Cl. G06F 17/00; G06Q 30/00; G06Q 20/00

(52) U.S. Cl. 700/232; 705/21; 705/14.38; 705/14.65

(57) ABSTRACT

An electric vehicle charging station (EVCS) that includes an electric vehicle charger adapted to provide electrical power to a vehicle; a network device adapted to communicate with a wireless network; and a point of sale device coupled to the electric vehicle charger and the network device. The point of sale device is adapted to facilitate consumer purchases of the electrical power and items other than the electrical power. The point of sale device includes: a user interface including a touch screen display, a credit card reader, a bar code reader, and a magnetic card reader, and a printer; a processor; and an application for execution on the processor to implement a method. The method includes: receiving a request from a consumer via the user interface; processing the request; and outputting a status of the request via the user interface.

### BACKGROUND OF THE INVENTION

The present invention relates generally to an electric vehicle charging station and more particularly to a combination electric vehicle charging system that includes an electric vehicle charger and a point of sale device.

Due to rising cost of petroleum and the fuels derived from it, the desire to improve efficiency to reduce air pollutants, and increasingly more restrictive regulatory requirements, the automotive industry has developed new types of vehicles that utilize a combination of power sources to provide the necessary energy for the propulsion of vehicles. Rather than rely solely on an internal combustion engine, these new vehicles, referred to as hybrid electric vehicles, utilize an internal combustion engine in combination with an electric motor. Versions of the hybrid electric vehicle may also supplement the charging of the batteries from the electric grid or other sources. Depending on the mode of operation, the vehicle will use the combustion engine, the electric motor, or a combination thereof. By using the electric motor at various times, the combustion engine could be shut off, reducing the amount of gasoline or other fuel consumed using electricity to power the motor instead. The electric motor is powered by batteries that are periodically recharged through a combination of a generator coupled to the combustion engine, regenerative breaking technology and from the local utility grid or other external source of electricity. Regenerative breaking allows the capture of energy that would otherwise be dissipated through heat when the vehicle is slowed down or brought to a stop. Another type of vehicle, a pure electric vehicle, also referred to as an all-electric vehicle, eliminates the internal combustion engine and relies solely on stored electrical energy in the vehicles batteries.

Pure electric vehicles add complications over hybrid electric vehicles, in that pure electric vehicles require significantly more electricity than hybrid electric vehicles. A typical hybrid electric vehicle requires a charge of 2-3 kilowatt hours (KWH) of electricity. In contrast, pure electric vehicles, such as the Nissan Leaf (manufactured by the Nissan Motor Company) for example, may require 24 KWHs of energy storage and other vehicles require charging in excess of 50 KWHs. Level 1 chargers and Level 2 chargers (as defined by the Society of Automotive Engineers (SAE)) are adequate to provide this level of charge. Level 3 chargers are now available in the range of 150 plus KWs and charging stations of 1,000 KW to 1,500 KW (1-1.5 MW) are expected to be available in the near future.

Current electric hybrid vehicles provide many advantages over internal combustion engine vehicles and previous generations of all-electric vehicles. A hybrid electric vehicle provides greater range and more flexibility for the operator. Since the all-electric vehicle needs to be charged periodically, and requires several hours at a minimum to recharge, the operator needs to remain aware of the level of charge remaining in the batteries to ensure they are able to return to their charging station. It should be appreciated that hybrid electric vehicles, in contrast, by having two different sources of propulsion do not carry the same risks due to the wide availability of fuels such as gasoline.

A typical hybrid electric vehicle uses a nickel metal hydride or lithium ion battery or the like to store electrical charge. When run in pure electric mode, the hybrid electric vehicle can only operate for short distances, 2 km-32 km for example, before requiring the use of the gasoline engine. Since the gasoline engine recharges the batteries, at least in part, the vehicle manufacturers need to balance the amount of battery storage against fuel efficiency to provide a vehicle that meets the consumer's performance expectations.

The hybrid electric vehicles include a receptacle that connects the batteries to a standard 110V or 220V household electrical outlet and allows the consumer to recharge the batteries using utility electric power rather than by burning gasoline or other fuel in a combustion engine. This allows the hybrid electric vehicles to have a longer range in electric mode of operation since larger capacity batteries may be used, resulting in vehicle that uses less gasoline and thus lower emission. It should be appreciated that all-electric vehicles have similar features, albeit without the internal combustion engine.

In addition to household electrical outlets, consumers may also use electric vehicle charging stations (EVCSs) to charge the batteries in their hybrid electric vehicles and all-electric vehicles. EVCSs may be located at locations such as commuter parking lots, gasoline stations, grocery stores and convenience stores. As battery technology improves pure electric vehicles (EV) will emerge requiring greater electrical charges and their owners will desire these charges to occur fast. These stations may provide fast charging capabilities and draw much greater current. It is envisioned that while these stations may start small many will grow to have up to six or eight Level 3 chargers each in the 400 to 480 volt and up to 200 KW of power more range and in aggregate providing 1 MW of power or more at the charging station vs. today's hybrid electric chargers providing 110 volt and around 1 KW of power. In addition to selling electrical power, some establishments associated with the EVCSs may be selling additional items such as food, magazines, and wireless fidelity (WiFi) access. The electrical power provided to the vehicle by the EVCS may be purchased by the consumer via a user interface provided at the EVCS. This capability, of allowing a consumer to purchase electrical power directly from an EVCS is suitable for its intended purpose, however there remains a need for expanding this capability to allow the consumer to purchase items other than electrical power directly from an EVCS.

### BRIEF DESCRIPTION OF THE INVENTION

According to one aspect of the invention, an electric vehicle charging station (EVCS) is provided. The EVCS includes an electric vehicle charger adapted to provide electrical power to a vehicle; a network device adapted to communicate with a wireless network; and a point of sale device coupled to the electric vehicle charger and the network device. The point of sale device is adapted to facilitate consumer purchases of the electrical power and items other than the electrical power. The point of sale device includes: a user interface including a touch screen display, a credit card reader, a bar code reader, and a magnetic card reader, and a printer; a processor; and an application for execution on the processor to implement a method. The method includes: receiving a request from a consumer via the user interface; processing the request; and outputting a status of the request via the user interface.

According to another aspect of the invention, an EVCS is provided that includes: an electric vehicle charger adapted to provide electrical power to a vehicle; a network device adapted to communicate with a network; and a point of sale device coupled to the electric vehicle charger and the network device. The point of sale device is adapted to facilitate consumer purchases of the electrical power and items other than the electrical power. The point of sale device includes: a user interface that includes an input device and an output device; a processor; and an application for execution on the processor to implement a method. The method includes receiving a request from a consumer via the input device; processing the request; and outputting a status of the request via the output device.

According to another aspect of the invention a method for purchasing items at an EVCS is provided. The method includes: receiving an electrical power request from a consumer to provide electrical power to a vehicle, the electrical power request received at the EVCS via a user interface; providing the electrical power to the vehicle in response to the electrical power request, the providing via an electric vehicle charger; receiving a purchase request from the consumer to purchase an item other than electrical power, the purchase request received at the EVCS via the user interface; receiving a specified method of payment for the item from the consumer, the receiving via the user interface; completing the purchase using the specified method of payment; and notifying the consumer that the purchase has been completed, the notifying in response to the completing and via the user interface.

According to another aspect of the invention a computer program product for purchasing items at an electric vehicle charging station is provided. The computer program product includes a tangible storage medium readable by a processing circuit and storing instructions for execution by the processing circuit for performing a method. The method includes: receiving an electrical power request from a consumer to provide electrical power to a vehicle; initiating providing the electrical power to the vehicle in response to the electrical power request; receiving a purchase request from the consumer to purchase an item other than electrical power; receiving a specified method of payment for the item from the consumer; completing the purchase using the specified method of payment; and notifying the consumer that the purchase has been completed, the notifying in response to the completing.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a block diagram of an electric vehicle charging station (EVCS) that may be implemented by an exemplary embodiment;

FIG. 2A depicts a block diagram of point of sale device and network device components of an EVCS that may be implemented by an exemplary embodiment;

FIG. 2B depicts a block diagram of an electric vehicle charger component of an EVCS that may be implemented by an exemplary embodiment;

FIG. 3 illustrates a flow diagram of a process for purchasing items at an EVCS that may be implemented by an exemplary embodiment; and

FIG. 4 depicts a block diagram of an exemplary system for providing EVCS functionality where the components are located in two different physical locations.

The detailed description explains embodiments of the invention, together with advantages and features, by way of example with reference to the drawings.

### DETAILED DESCRIPTION OF THE INVENTION

An exemplary embodiment of the present invention provides a consumer with the ability to purchase a utility and items other than a utility at a utility replenishment station. An exemplary embodiment ties together marketing and point of sale features into a single system, and provides the products and services to the consumer through payment using cash, credit card or by adding the payment directly to the consumer's utility bill. Another embodiment provides incentives, such as coupons for example, that provide discounts to the consumer to purchase products or receive a free or reduced rate electrical charge. Still another embodiment provides for and advertising based system that allows the consumer to have a reduced rate or free electrical charge.

In an exemplary embodiment, a utility replenishment station (or electric vehicle charging station (EVCS)) is capable of providing electrical charging as well as sales or promotional opportunities using a variety of embedded or accessible systems. In an exemplary embodiment, the charging stations are Level 1 and/or Level 2. In alternate exemplary embodiments, other charging stations (e.g., Level 3 charging stations) are implemented. As technology advances, chargers with other specifications and designations will be developed, and supported by exemplary embodiments described herein. In addition to providing electrical charging in the range of 1.9 kilowatts (KW) to 1,500 KW (and greater) an exemplary charging station includes: communication capability (back to the utility, to credit card financial institutions, to the electric vehicle operator); a press screen monitor capable of interacting with the consumer and remote systems (including banking, utility, convenience store, quick service restaurant, and others); a credit card reader; capability compatible with payment for goods and services directly to the consumers utility bill; a magnetic card reader capable of accepting payment; a bar code reader capable of accepting payment or crediting the sale of electricity to an advertising account; and a wireless fidelity (WiFi) system capable of providing Internet connectivity to a user(s) waiting near the charging station who may have a laptop, Internet capable telephone, or other WiFi compatible device.

As used herein, the term “utility” refers to a commodity that is provided to a consumer by a utility provider. Utility providers typically provide a commodity product that is sold to the general public within a local or regional area. The products and services provided by utility providers include, but are not limited to: electrical power, natural gas, oil, city water, cable television, and telephone service. Generally, there are only a single or small group of utility companies within a local or regional area and the operations of a utility company may be regulated by governmental agencies. In regions where production of electricity is deregulated, the utility provider may be an energy producer (e.g., an electrical generator) or an electrical distribution provider. As used herein, the term “utility account” refers to an account set up by a utility provider in order to track utility usage/consumption at a physical location, and to bill a responsible party (e.g., a consumer) for the utility usage. In the past, the utility account was associated with consumption at a fixed location, such as a consumer's home for example.

In an exemplary embodiment, the utility is electrical power, the utility provider is an electrical distribution company, and the utility replenishment station is an EVCS. The EVCS includes equipment for charging electric vehicles and other ancillary services as described herein. This equipment in some cases is integrated together into a single unit, or in other cases it may be physically separated into logical components that can be operated separately. In an example scenario, a consumer is using an EVCS located at a convenience store to charge the batteries in his electric vehicle. While waiting for the batteries to charge, the consumer may want to purchase some items at the convenience store (e.g., lunch and a newspaper). According to exemplary embodiments described herein, the consumer can purchase the items through a user interface on the EVCS, thus providing the consumer with the convenience of purchasing the electrical power and the additional items at the same location and in the same manner (e.g., similar user interface, same method of payment).

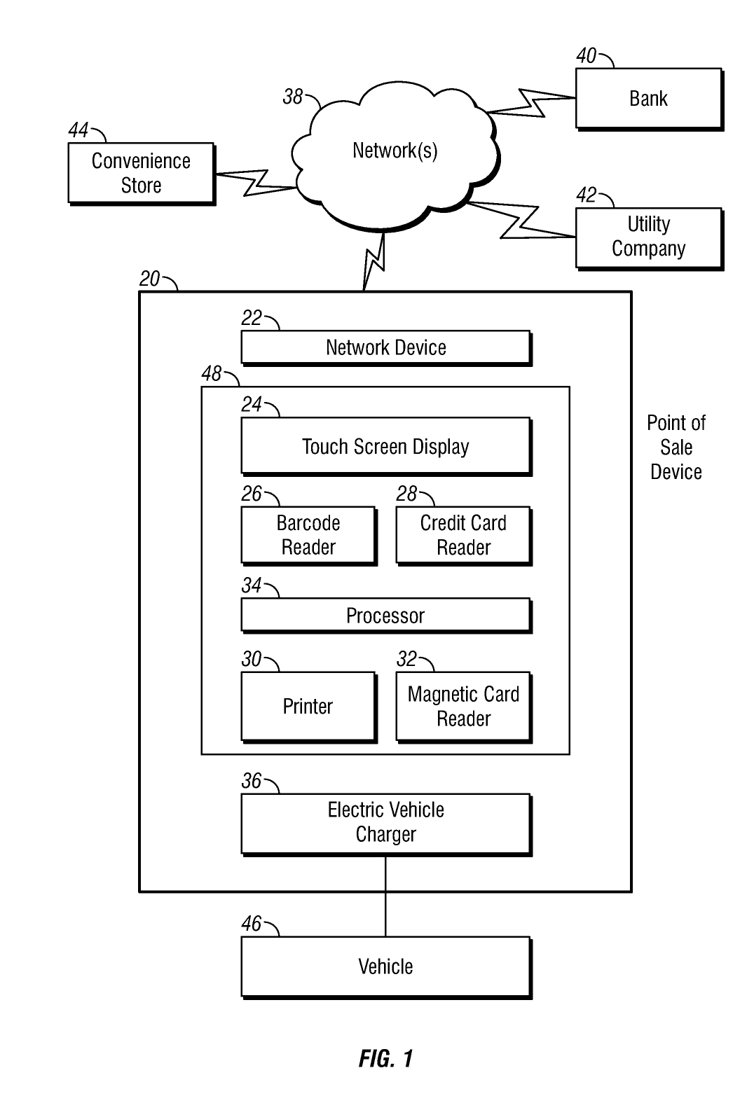

FIG. 1 depicts a block diagram of an EVCS 20 that may be implemented by an exemplary embodiment. The EVCS 20 depicted in FIG. 1 includes an electric vehicle charger 36 to provide electric power to a vehicle 46 (e.g., a hybrid electric vehicle or an all-electric vehicle). The EVCS 20 also includes embedded wireless fidelity (WiFi, IEEE 802.11 compliant communications) capability that is provided by a network device 22 (made up of one or more components) to allow consumers to access a network(s) 38 (e.g., the Internet). In an exemplary embodiment, the WiFi capability is used to provide Internet connectivity to a consumer(s) waiting near the EVCS 20 who may have a laptop computer, Internet capable mobile telephone, or other WiFi compatible device. In addition, the WiFi capability may be used by the EVCS 20 to provide communication capability back to a utility company 42 (e.g., to charge purchases to an existing utility account) and to credit card financial institutions such as a bank 40 (e.g., to charge purchases to a credit card). It should be appreciated that while the embodiments herein discuss the use of WiFi for communication, this is for exemplary purposes and the claimed invention should not be so limited. In other embodiments, the EVCS 20 may include different or additional devices/circuits that operate on communications protocols. These protocols include, but are not limited to: a satellite device, a CDMA compliant cellular device, a GSM compliant cellular device, a radio frequency device, a IEEE 802.15.4 device commonly referred to as Zigbee, and a Bluetooth compliant device.

In addition to the electric vehicle charger 36 and the network device 22, the EVCS 20 depicted in FIG. 1 also includes various other components that are referred to herein collectively as a point of sale device 48. In an exemplary embodiment, the point of sale device 48 facilitates consumer purchases of electrical power and other items (e.g., consumables, network connections).

The exemplary point of sale device 48 depicted in FIG. 1 shows several user interface devices including: a touch screen display 24, a credit card reader 28, a magnetic card reader 32, a bar code reader 26, and a printer 30 (e.g., for printing a receipt and/or a coupon). In an exemplary embodiment, the touch screen display 24 is capable of interacting with the consumer, the magnetic card reader 32 is capable of accepting payment, and the bar code reader 26 is capable of accepting payment or crediting the sale of the electrical power to an advertising account. In an alternate exemplary embodiment, the point of sale device 48 also includes one or both of a microphone for receiving input from a consumer, and a speaker for providing an output to the consumer.

Another component of the point of sale device 48 is a computer processor 34 where application code is executed to coordinate the processes performed by the EVCS 20 that are described herein. In an exemplary embodiment, the application receives the requests that are entered into the EVCS 20 via the user interface devices (or via the network 38), processes the requests (or initiates the processing of the requests), and outputs a status of the requests (e.g., results of the processing) to one or more of user interface devices. User interface devices that receive data, such as requests, are referred to herein as “input devices” and user interface devices that output data, such as a status, are referred to herein as output devices.” In an exemplary embodiment, the application code executing on the computer processor 34 coordinates communication, via the network 38, with remote systems at locations including, but not limited to a bank 40, a utility company 42, and a convenience store 44.

In an exemplary embodiment, application code and/or firmware on the computer processor 34 is updated via the network 38. The application code may be updated with a new version and/or fixes to a current version. In an exemplary embodiment, the updates may impact the look and feel of one or more of the user interface devices, the types of coupons and other marketing products offered at the EVCS 20 offered, and may result in adding or deleting a remote system to be communicated with by the EVCS 20.

In an exemplary embodiment, an over-the-air-programming (OTAP) command is received from a remote controller. The executable update is encrypted before it is sent. Upon receipt and prior to self-updating, the package is decrypted and a checksum verified. This OTAP process is agnostic to the actual communication medium. System problems can be fixed and fixes easily distributed, and new functionality can be added. For example, a utility may add a new energy efficiency program, or a business may elect to introduce a promotional program or a new functionality. Using an OTAP, the changes to the system can be easily and readily accommodated.

A request received by the application may be a request to purchase electrical power or an item other than electrical power. In an exemplary embodiment, a request to purchase electrical power is processed by sending a command to the electric vehicle charger 36 to initiate providing the vehicle 46 with the electric power. In addition, a status command, indicating that the consumer should connect the vehicle 46 to the electric vehicle charger 35 may be output to the consumer via an output device (e.g., the touch screen display 24).

In an exemplary embodiment, a request to purchase an item other than electrical power may be processed by requesting the consumer to scan a barcode located on the item using the barcode reader 26. Data read from the barcode can then be used by the application to determine the cost of the item and, optionally to provide an update to an inventory system (e.g. via the network 38). In an exemplary embodiment, the point of sale device 20 interfaces directly into the information technology systems utilized by the retail establishment, such as the convenience store 44. In this case, purchases made from the point of sale device 20 are processed in the same manner as purchases made in the convenience store 44.

In an alternate exemplary embodiment, the point of sale device 20 is not integrated with the information technology systems utilized by the seller of the items other than electrical power and information about the purchase has to be communicated to the seller. In an exemplary embodiment, after the consumer selects items to purchase from a menu of items displayed on the touch screen display 24, the consumer pays for the selected items at the point of sale device 20 and a receipt is printed. The consumer enters the convenience store 44, selects the purchased items, and presents the receipt to a clerk before exiting the convenience store 44. In another exemplary embodiment, a clerk at the convenience store receives the receipt electronically. In an exemplary embodiment, the clerk collects the items purchased and the consumer picks them up or has them delivered to his vehicle 46. In other exemplary embodiments, a text message with the bar code is sent to a consumer telephone instead of printing a paper receipt for the consumer. The previous examples are for exemplary purposes and the claimed invention should not be so limited.

In an exemplary embodiment, the consumer specifies a payment method (e.g., via an input device). Payment methods include, but are not limited to, cash (e.g., inserted into a cash handling device on or in communication with the EVCS 20), charging the purchase to an existing utility account, and charging the purchase to a credit card account. In exemplary embodiment, under certain conditions (e.g., coupon received, particular time of day, purchase of a certain amount or type of items other than electrical power), the electrical power is provided to the consumer at no cost to the consumer. In this case, the cost of the electrical power may paid for by one or more of the utility company 42, the convenience store 44, and another third party.

The request received by the application may be a request by the consumer to access a network 38 such as the Internet. In this case, the application processes the request by providing information about how to access the Internet and a password (if one is required to access the network 38 via the network device 22).

The request received by the application may be a request to be notified of a charging status of the vehicle 46 along with contact information for the consumer. This request to be notified may be received from the consumer via a user interface on the point of sale device 48 or it may be received from the consumer at a remote device (e.g., a cellular telephone, a laptop computer) via the network 38.

In an exemplary embodiment, the processor 34 is in communication, via the network 38, with other processors located on other EVCSs. In some cases, the other processors may be peer processors with the communication including sharing of data. In other cases, the other processors may be master processors that direct software and/or other updates to be applied to the processor 34.

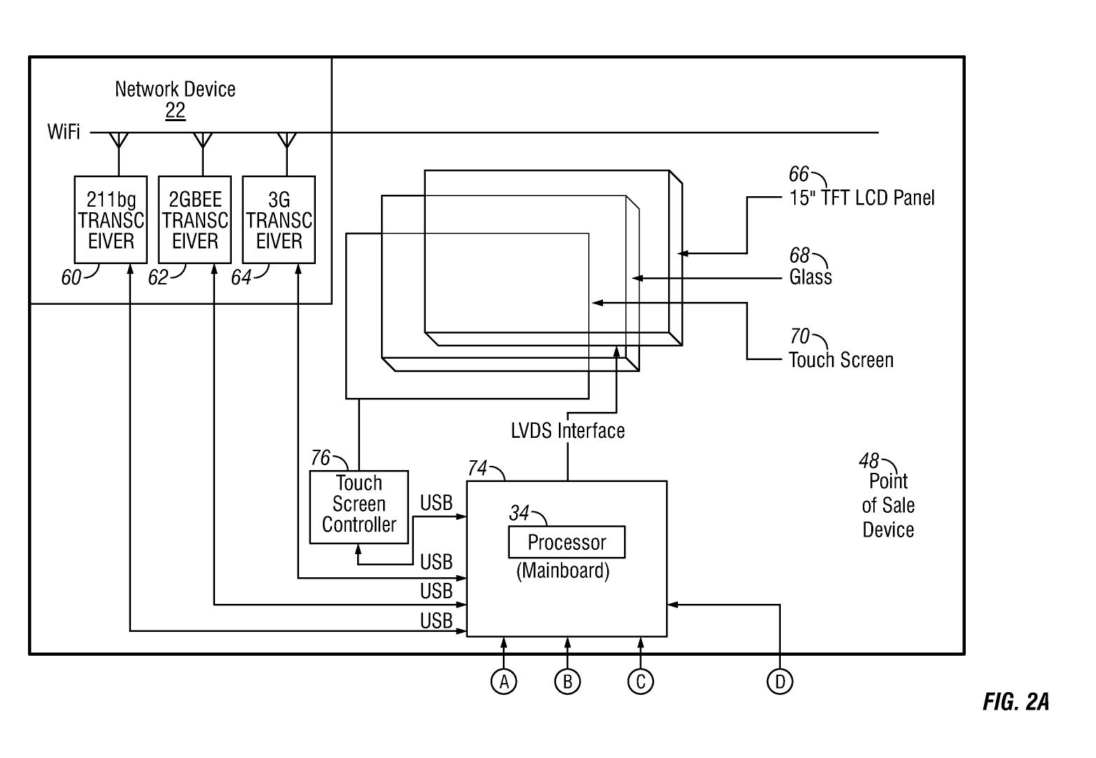

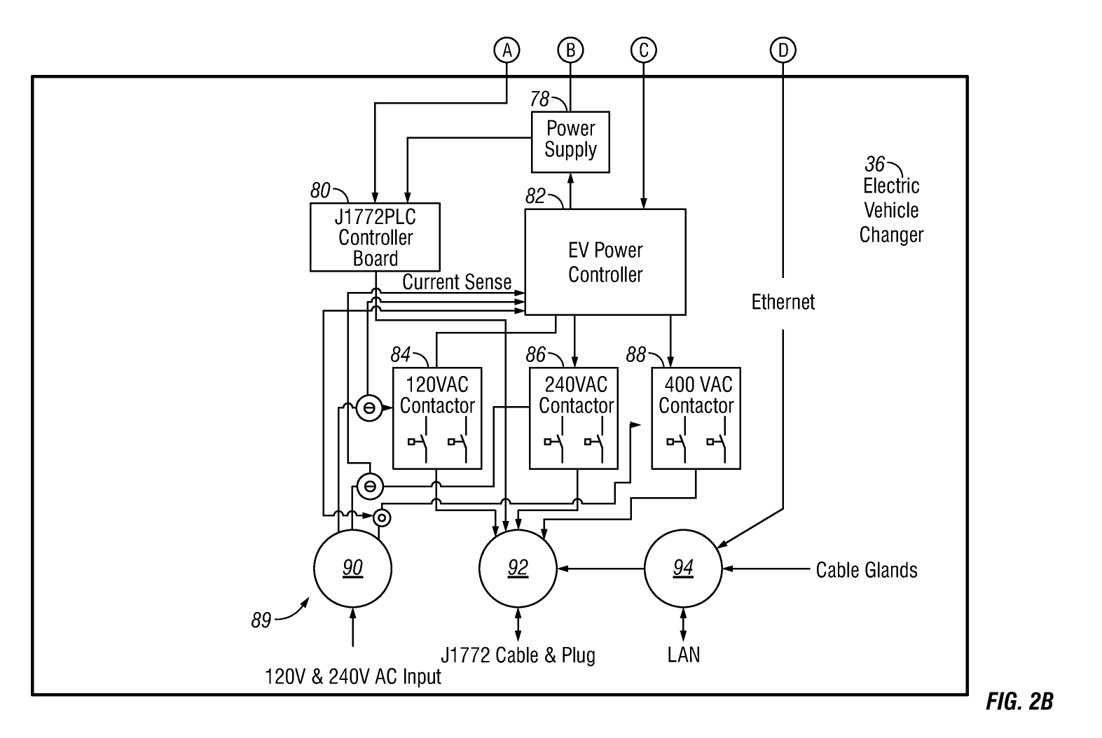

FIGS. 2A and 2B depict a more detailed block diagram of portions of the EVCS 20 depicted in FIG. 1 that may be implemented by an exemplary embodiment. The portion of the EVCS 20 depicted in FIG. 2A includes an exemplary network device 22, and point of sale device 48. The portion of the EVCS 20 depicted in FIG. 2B includes an exemplary electric vehicle charger 36.

As shown in FIG. 2A, an exemplary network device 22 is implemented by an IEEE 802.11 (WiFi) compliant transceiver 60, a ZIGBEE transceiver 62, and a cellular 3G transceiver 64. As discussed above, the EVCS 20 may implement other communications protocols, including but not limited to satellite, CDMA compliant cellular, GSM compliant cellular, radio frequency, and Bluetooth. These communications capabilities may be used to allow the EVCS 20 to communicate with the vehicle 46, network 38, convenience store 44, bank 40, or utility company 42. In one embodiment, the EVCS 20 communicates directly with adjacent retail establishments. In an exemplary embodiment, the EVCS 20 communicates with one or more other EVCSs via the network 38.

Also as shown in FIG. 2A, an exemplary point of sale device 48 includes a touch screen display 24 that includes an LCD panel 66, glass 68, a touch screen 70, and a touch screen controller 76. The point of sale device 48 depicted in FIG. 2A also includes a main processing board 74 where the computer processor 34 is located. As described previously, an application to coordinate the processes performed by the EVCS 20 is executed on the computer processor 34. As will be discussed in more detail herein, the point of sale device 48 provides the user interface and appropriate control systems to allow the consumer to interact with the EVCS 20 and allow charging of the vehicle 46.

While it is envisioned that the electric vehicle charger typically comes with the touch screen display for end user interactivity, the display may not be always necessary, as during a valet operation. Space consideration at the site of the installation may also dictate that the display be separated from the electric vehicle charger. As such, the touch screen display can be optionally opted out or it can be optionally separated from the vehicle charger during installation.

In another embodiment of the electric vehicle charger and touch screen display, the unit optionally has a built-in camera or web-cam to observe and record usage metrics.

In another embodiment of the device, the unit can function as a point-of-sales device for the store location it is installed in. An example of this would be to purchase a movie ticket outside a movie theater while still in the parking lot without having to stand in line inside the theater.

In another embodiment of the device, the unit can function as a digital advertising platform. It can broadcast store promotions and allow users to interact with the ads through touch screen or other input devices already mentioned.

Shown in FIG. 2B, is an exemplary electric vehicle charger 36 that includes a power supply 78, a controller board 80, an electric vehicle (EV) power controller 82 that are coupled to receive and transmit signals and data to allow charging of the vehicle 46. In this embodiment, the power supply 78, controller board 80, and EV power controller 82 are coupled to communicate with the processor board 74 in the point of sale device 48. In this arrangement, the processor 34 may execute instructions in response to the consumer's interaction with the touch screen 24 in the point of sale device 48 that result in the flow of the electrical power to the vehicle 46.

The electric vehicle charger 36 further includes a plurality of connectors 89. Each of the plurality of connectors 89 has a cable gland associated with a particular functionality. The connectors 89 include an electrical charge connector 90, a vehicle communications connection 92 and a network connection 94.

In general, the rate at which the vehicle 46 may be charged will depend on the input and voltage level of the electrical power being transferred to the vehicle 46. In this embodiment, the electrical charge connector 90 is coupled to receive electrical power from one of three contactors, namely a 120 VAC contactor 84, a 240 VAC contactor 86, or a 400 VAC contactor 88. The contactors 84, 86, 88 are coupled to receive signals from the EV power controller 82 to allow electrical power to flow to the vehicle 46. It should be appreciated that the EV power controller 82 is configured to allow only one of the contactors 84, 86, 88 to be closed at a given time and the charger 36 may include appropriate interlocks (not shown) to prevent the flow of electrical power through multiple contactors simultaneously.

In one embodiment, the connectors 89 are combined into a single cable (not shown) that interconnects the vehicle 46 with the EVCS 20. In one embodiment, the cable complies with the Society of Automotive Engineers (SAE) J1772 standard for electric vehicle charging. In operation, when the consumer couples the vehicle 46 to the EVCS 20, a controller on the vehicle (not shown) communicates with the EV power controller 82 and controller board 80 via connection 92. The signals exchanged between the vehicle 46 and the EV power controller 82 includes data on the level of charging (e.g. voltage and power) the vehicle may accept and the level of charge in the battery for example. Upon receipt of this data and an enabling signal from the point of sale device 48, the EV power controller 82 may initiate charging of the vehicle 46. The vehicle controller may further communicate with network 38 via network connection 94.

It should be appreciated that while the EVCS 20 and electric vehicle charger 36 are illustrated as having multiple controllers with discrete functionality, this was for exemplary purposes and the claimed invention should not be so limited. The functionality described herein may also be embodied in a single controller, such as processor board 74 for example.

In an exemplary embodiment, the power supply 78 is connected to an electrical grid and/or an energy storage system for providing the electrical charge to the vehicle. In an exemplary embodiment, the energy storage system is another vehicle and the EVCS 20 provides the ability to connect to the other vehicle in order to transfer power from the other vehicle. An exemplary embodiment supports one vehicle receiving an electrical charge from another vehicle, without an inverter and via the EVCS 20. Another exemplary embodiment supports the receiving of an electrical charge from a vehicle by another local direct current (DC) user (e.g., building heat), via the EVCS 20 and without the user of an inverter. In this manner, vehicles stored for extended stays (e.g., at an airport parking lot) can be automatically accessed and their stored energy used to provide a charge to a nearby electric vehicle needing a charge. This capability may be particularly useful, for example, during a period of high electrical demand on the utility grid. Similarly, the automated ability to go from a vehicle to another DC user may be used to provide power for a building during periods of high electrical demand on the utility grid. In either case, an inverter is not required, thus avoiding the capital cost and the efficiency loss of converting from DC to AC. This equipment enabling this transfer of electricity one electric vehicle to another or to another DC user may be integral to the EVCS or physically separated from it. In the case of being physically separated from the base EVCS, it has the capability to either communicate with the EVCS real time and/or to store its data and communicate its data at a later time when communication is re-established.

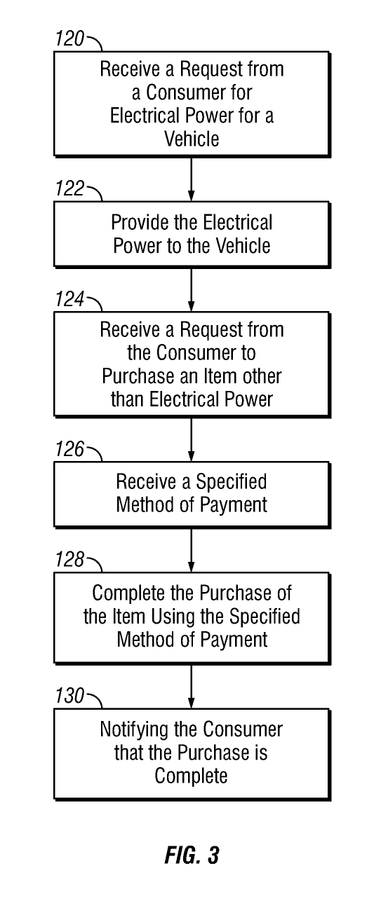

Referring now to FIG. 3 a flow diagram is illustrated of a process for purchasing items at the EVCS 20 that may be implemented by an exemplary embodiment. In an exemplary embodiment, this process is facilitated by the application executing on the processor in the EVCS 20. At block 120, a request for electric power for an electric vehicle 46 is received from a consumer via a user interface device. At block 122, the electrical power is provided to the electric vehicle 46 by the electric vehicle charger 36 when the consumer plugs the electric vehicle 46 into the electric charger 36. In an exemplary embodiment, the application executing on the processor 34 initiates the charging by sending an enabling command to the electric vehicle charger 36 specifying an amount of electrical power to provide to the electric vehicle 46. It should be appreciated that the electric vehicle charger 36 will compare the specified amount with signals received from the vehicle 46 to determine if the specified amount is compatible with that allowable by the vehicle 46 battery or charging components. In one embodiment, where such an incompatibility exists, the consumer will be alerted via the touch screen device 70.

At block 124, a request to purchase an item other than electrical power is received from the consumer, the receiving via a user interface device. In an exemplary embodiment, the purchase request is received by the application executing at the EVCS 20. At block 126, a specified method of payment is received from the consumer. The method of payment may include, but is not limited to, credit card, utility account, cash, and coupon. At block 128, the purchase is completed using the specified method of payment. In an exemplary embodiment, completing the purchase includes communicating with a bank 40 or a utility company 42 via the network 38 to ensure that the consumer is authorized to charge the purchase to a credit card or utility account, respectively. In addition, the application may prompt the user, via a user interface device, to provide identifying information (e.g., password, social security number) for use in verifying that the consumer is authorized to charge the purchase. At block 130, the consumer is notified, via the user interface on the EVCS 20, that the purchase is complete. In an exemplary embodiment, the consumer will be notified that the purchase cannot be completed, for example if the consumer is not authorized to charge the purchase to a specified credit card or utility account, or alternatively if the consumer does not provide enough cash to cover the purchase.

Following are several example scenarios of how a consumer may utilize exemplary embodiments of the present invention. In a first scenario, an electric vehicle commuter uses a parking lot having an EVCS 20. The electric vehicle 46 may be parked in the parking lot for a whole day or for a portion of the day. Thus, the electric vehicle 46 is being charged while the consumer is at work, out shopping, or attending a movie for example. The parking lot owner may or may not provide the charging service for free or at an abated rate or at full price. The electric vehicle operator, or consumer, enters his contact information (e.g., cell phone number, email address, text message address) into the EVCS 20. The consumer is then notified of the status of his electric vehicle 46 during the day, the notifying at selected intervals or upon the occurrence of selected events. The consumer may establish a price point for receiving a charge while initially at the EVCS 20. He may remotely override that price point during the course of the day to reflect his desire to obtain a charge. For example, if the consumer initially selected a price point that wouldn't appear to allow topping off or a convenience charge he may change his prior instructions. The consumer can also be notified of other charging stations (including pricing data, location, directions to the station, current queuing time, etc.), which may be preferential to the consumer. The billing for this service, including parking and kilowatt charge, may be paid for, based on consumer preference, by credit card, utility bill, or cash. Consistent with applicable local law if the consumer is behind on his utility bill the system could refuse to allow the transaction to be completed unless a credit card or cash is used for the purchase including payment of a specified amount of the delinquent utility bill.

In another scenario, an electric vehicle operator drives to a retail establishment 44, such as a convenience store, a restaurant, or a coffee shop for example. The retail establishment 44 has an EVCS 20 to allow the operator to get a convenience charge for the vehicle 46. In this scenario, the operator's intention may be to obtain a sufficient charge to complete the next leg of a planned journey for example. Depending on the level of charge in the vehicle battery and the level of charge provided, this might take the electrical EV from a 30% charge to a 60% or greater charge within 20-40 minutes. The operator, or consumer, couples the vehicle 46 to the EVCS 20 and enters the retail establishment 44 to buy a snack, a newspaper and/or to make other purchases. The consumer returns to the vehicle 46 where he connects a WiFi compatible device into the network 38 using the network device 22 in the EVCS 20. All or a part of the charges for the purchases may be paid for by a credit card, cash or by billing them to consumer's utility bill. Alternatively, the store could issue the consumer a magnetic card or bar code, allowing the consumer to get the electricity for free or at a discount. The WiFi connection could similarly also be free or at a discount to the consumer.

In another scenario, an advertiser has an e-marketing campaign that advertises a parking lot that typically has low nighttime occupancy. In the example case described herein, the e-marketing campaign targets people attending a theater. The advertiser could advertise that the consumer could get a free electric vehicle charge while going to the theater. The advertiser could allow the consumer to print off a unique barcode capable of having a one time use or limited use capability. In this example, the consumer would use a home, office, or other printer to print out the barcode for use at the parking lot. The consumer would then arrive at the parking lot and scan the barcode to initiate a free charge. Assuming that the parking lot is in a non-optimal location relative to the theater, the EVCS 20 could identify other services to the consumer, such as the availability of taxi cabs (e.g., via the touch screen) for example. On the touch screen the consumer could request that the taxi cab come to pick him up and take him to the theater. The consumer could also use the touch screen on the EVCS 20 to make a dinner reservation for after the show and print out a magnetic card or a barcode to get a discount at the restaurant. One or more of the transactions could be charged directly to the consumer's credit card or it could be charged to his utility account (e.g., via a smart card).

In another scenario, the EVCS 20 is used to influence or train the consumer's behavior. The EVCS 20 may offer to provide the consumer with free charging (e.g., the first twenty minutes, the first 4 KWHs, the entire charge) in return for actions such as, but not limited to: the consumer buying a particular product, the consumer spending a specified dollar amount at a store, the consumer accessing a sequence of advertisements, and the consumer using a particular payment method.

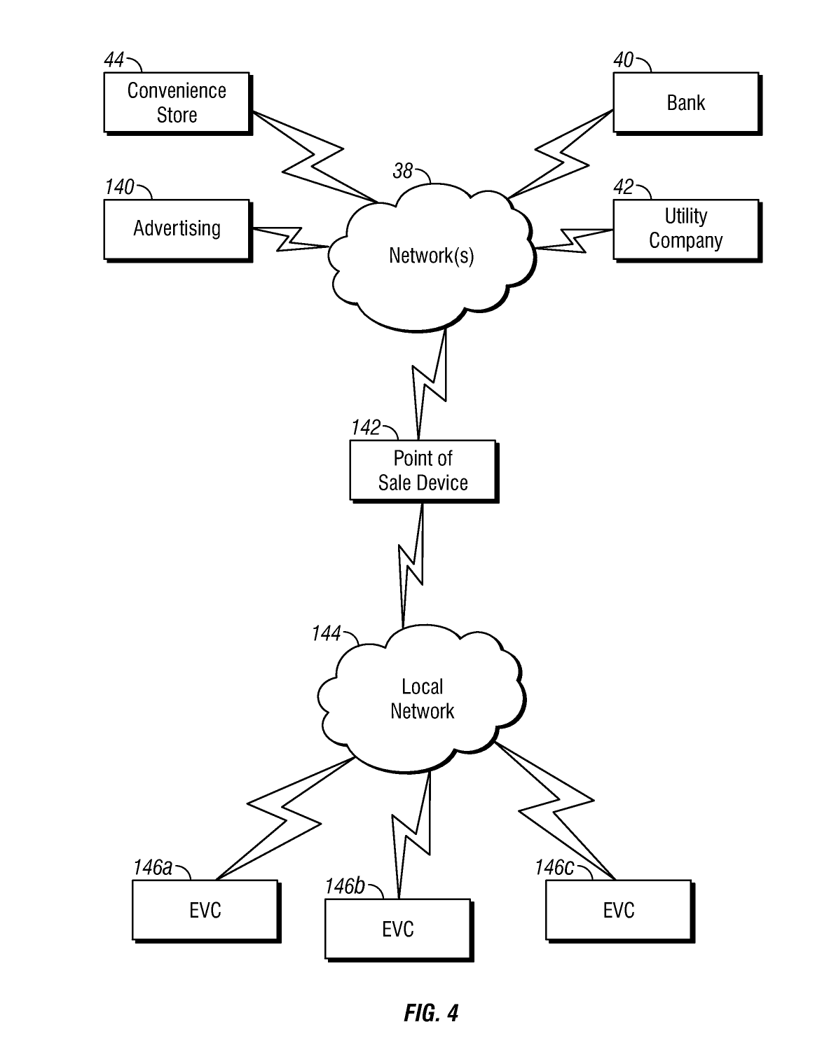

FIG. 4 depicts a block diagram of an exemplary system for providing EVCS functionality where the components are located in two different physical locations. The system of FIG. 4 includes a point of sale device 142 that is physically separated from one or more electric vehicle chargers (EVCs) 146. The point of sale device 142 is in communication with the convenience store 44, the bank 40, the utility company 42 and an advertising server 140 via the network 38. In the exemplary system depicted in FIG. 4, the point of sale device 142 is in communication with the EVCs 146 via a local network 144. Other manners of communication may be implemented by exemplary embodiments, such as a physical connection or communication via the network 38. The advertising server 140 and associated functions described herein may also be utilized by the exemplary EVCS 20 depicted in FIG. 1.

In one example, the system depicted in FIG. 4 is located in a parking lot at a large retail establishment. A consumer drives to an area in the parking lot where the EVCs 146 are located and plugs his electric vehicle 46 into EVC 146a. The consumer then goes to the point of sale device 142 where the display for EVC 146a is located, and using a touch screen display (or other user interface means), selects EVC 146a and an amount of charge to be purchased. In an exemplary embodiment, the point of sale device 142 displays advertisements targeted to electric vehicle operators after the consumer has started the purchase of the electrical charge, or has otherwise indicated that he is an electric vehicle operator. In an exemplary embodiment, the advertisements are received via the advertising server 140 and may include, but are not limited to; video clips, graphics, pictures, and audio messages. In an exemplary embodiment, the advertisements are updated with fresh content throughout the day. In an exemplary embodiment, data known about the consumer is utilized to target the advertising to the consumer. This data may include current geographic location, home address, type of payment method, type and frequency of electrical charge purchases, and any other data that can be ascertained about the consumer.

In an exemplary embodiment, once the purchase is complete, the point of sale device 142 displays advertisements intended for the general public. These advertisements may be received from the advertising server 140 and include any content related to the general public such as, but not limited to: sale items at the retail establishment, and local events.

In another example, the system depicted in FIG. 4 is located at a convenience store where space is at a premium and a cluster of EVCs 146 share a common point of sale device 142. In another example, the system depicted in FIG. 4 is located at a parking garage where a parking garage employee enters purchase requests for consumers at a centrally located point of sale device 142.

In another exemplary embodiment, the EVCs 146 include an additional display (or other user interface such as an interactive touch screen display) physically located on the EVCs 146 for displaying advertising targeted at electric vehicle operators. In an exemplary embodiment, these advertisements are received via the advertising server 140. In an exemplary embodiment, data known about the consumer is utilized to target the advertising to the consumer. This data may include current geographic location, home address, type of payment method, type and frequency of electrical charge purchases, and any other data that can be ascertained about the consumer.

In a further exemplary embodiment, a web-cam is incorporated into, or is in communication with, the EVCs 146 and/or the point of sale device 142 in order to gather data about the consumer or about potential consumers. The data from the web-cam may also be used to determine the effectiveness of advertisements. Data from the web-cam(s) can be used to determine demographics and/or to count impressions. In an exemplary embodiment, as the advertisements are updated with fresh content throughout the day, the web-cam can be used to determine what type of consumer stops to view or interact with the advertisement. In addition, the web-cam(s) may be used as a security device to prevent vandalism. Further, the web-cam(s) may be used to assist in patrolling and/or providing security services to a parking lot or parking garage. These features related to the web-cam may also be implemented by the exemplary system depicted in FIG. 1.

The previous scenarios are intended to be exemplary in nature and are not intended to be limiting in any manner, as a myriad of different usage scenarios may be implemented by exemplary embodiments of the present invention.

Exemplary embodiments provide a convenient manner for consumers to purchase items at the same location where they purchase electric power. The ability to purchase both electric power and items other than electric power from the same device provides a convenience to the consumer. In addition, the consumer can avoid having to wait in line to purchase the items.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that may contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, may be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. An electric vehicle charging station comprising:
an electric vehicle charger adapted to provide electrical power to a vehicle;
a network device adapted to communicate with a wireless network; and
a point of sale device coupled to the electric vehicle charger and the network device, the point of sale device adapted to facilitate consumer purchases of the electrical power and items other than the electrical power, the point of sale device comprising:
a user interface comprising a touch screen display, a credit card reader, a bar code reader, and a magnetic card reader, and a printer;
a processor; and
an application for execution on the processor to implement a method comprising:
receiving a request from a consumer via the user interface;
processing the request; and
outputting a status of the request via the user interface.

2. The electric vehicle charging station of claim 1, wherein the request comprises a request to purchase the electrical power, and the processing the request comprises sending a command to the electric vehicle charger to initiate providing the vehicle with the electrical power and charging the purchase to a utility account or a credit card account.

3. The electric vehicle charging station of claim 1, wherein the request comprises a request to purchase an item other than the electrical power and the processing the request comprises charging the purchase to a utility account or to a credit card account.

4. The electric vehicle charging station of claim 1, wherein the request is a request for electrical power and the processing the request comprises sending a command to the electric vehicle charger to initiate providing the vehicle with the electrical power, the electrical power provided at no cost to the consumer.

5. The electric vehicle charging station of claim 1, wherein the request comprises a request to access the wireless network.

6. The electric vehicle charging station of claim 1, wherein the request comprises a request to be notified of a charging status of the vehicle and contact information for the consumer.

7. The electric vehicle charging station of claim 1, further comprising printing a coupon on the printer.

8. The electric vehicle charging station of claim 1, wherein the request comprises a request to honor a coupon scanned by the bar code reader.

9. The electric vehicle charging station of claim 1, wherein the method further comprises receiving a request from a remote device.

10. The electric vehicle charging station of claim 1, wherein a source of the electrical power includes an electrical grid.

11. The electric vehicle charging station of claim 1, wherein a source of the electrical power includes an energy storage system.

12. The electric vehicle charging station of claim 1, wherein a source of the electrical power includes another vehicle.

13. The electric vehicle charging station of claim 1, wherein the point of sale device and the electric vehicle charger are physically separated by a distance.

14. The electric vehicle charging station of claim 13, wherein the electric vehicle charger comprises a display screen.

15. The electric vehicle charging station of claim 14, wherein at a point in time the display screen in the electric vehicle charger displays an advertisement and the touch screen display in the point of sale device display an other advertisement.

16. An electric vehicle charging station comprising:
an electric vehicle charger adapted to provide electrical power to a vehicle;
a network device adapted to communicate with a network; and
a point of sale device coupled to the electric vehicle charger and the network device, the point of sale device adapted to facilitate consumer purchases of the electrical power and items other than the electrical power, the point of sale device comprising:
a user interface comprising an input device and an output device;
a processor; and
an application for execution on the processor to implement a method comprising:
receiving a request from a consumer via the input device;
processing the request; and
outputting a status of the request via the output device.

17. The electric vehicle charging station of claim 16, wherein the processing the request comprises communicating with a host system via the network.

18. The electric vehicle charging station of claim 16, wherein the request comprises a request to purchase the electrical power, and the processing the request comprises sending a command to the electric vehicle charger to initiate providing the vehicle with the electrical power and charging the purchase to a utility account or a credit card account.

19. The electric vehicle charging station of claim 16, wherein the request comprises a request to purchase an item other than the electrical power and the processing the request comprises charging the purchase to a utility account or to a credit card account.

20. The electric vehicle charging station of claim 16, wherein the request is a request for electrical power and the processing the request comprises sending a command to the electric vehicle charger to initiate providing the vehicle with the electrical power, the electrical power provided at no cost to the consumer.

21. The electric vehicle charging station of claim 16, wherein the request comprises a request to access the network.

22. The electric vehicle charging station of claim 16, wherein the request comprises a request to be notified of a charging status of the vehicle and contact information for the consumer.

23. The electric vehicle charging station of claim 16, further comprising outputting a coupon from the output device.

24. The electric vehicle charging station of claim 16, wherein the request comprises a request to honor a coupon entered via the input device.

25. The electric vehicle charging station of claim 16, wherein the method further comprises receiving a request to a remote device.

26. The electric vehicle charging station of claim 16, wherein the method further comprises outputting the status to a remote device.

27. The electric vehicle charging station of claim 16, wherein the input device comprises a touch screen.

28. The electric vehicle charging station of claim 16, wherein the input device comprises at least one of a barcode reader, a magnetic card reader, and a smart card reader.

29. The electric vehicle charging station of claim 16, wherein the output device comprises at least one of a display screen, a printer, and a speaker.

30. The electric vehicle charging station of claim 16, wherein a source of the electrical power includes an electrical grid.

31. The electric vehicle charging station of claim 16, wherein a source of the electrical power includes an energy storage system.

32. The electric vehicle charging station of claim 16, wherein a source of the electrical power includes an other vehicle.

33. The electric vehicle charging station of claim 16, wherein the point of sale device and the electric vehicle charger are physically separated by a distance.

34. The electric vehicle charging station of claim 32, wherein the electric vehicle charger comprises a display screen.

35. The electric vehicle charging station of claim 34, wherein at a point in time the display screen in the electric vehicle charger displays an advertisement and the output device in the point of sale device display an other advertisement.

36. A method for purchasing items at an electric vehicle charging station (EVCS), the method comprising:
receiving an electrical power request from a consumer to provide electrical power to a vehicle, the electrical power request received at the EVCS via a user interface;
providing the electrical power to the vehicle in response to the electrical power request, the providing via an electric vehicle charger;
receiving a purchase request from the consumer to purchase an item other than electrical power, the purchase request received at the EVCS via the user interface;
receiving a specified method of payment for the item from the consumer, the receiving via the user interface;
completing the purchase using the specified method of payment; and
notifying the consumer that the purchase has been completed, the notifying in response to the completing and via the user interface.

37. The method of claim 36, further comprising:
receiving a status notification request;
receiving a contact method from the consumer;
periodically providing status information to the consumer via the contact method.

38. The method of claim 36, wherein the method of payment comprises a coupon.

39. The method of claim 36, further comprising outputting a coupon via the user interface.

40. The method of claim 36, wherein a source of the electrical power includes an electrical grid.

41. The method of claim 36, wherein a source of the electrical power includes an energy storage system.

42. The method of claim 36, wherein a source of the electrical power includes an other vehicle.

43. The method of claim 36, wherein the item is purchased from a seller, and the method further comprises outputting a receipt of the purchase to the consumer, wherein the consumer presents the receipt to the seller in return for the item.

44. The method of claim 43, wherein the receipt is a paper receipt.

45. The method of claim 43, wherein the receipt is electronic.

46. A computer program product for purchasing items at an electric vehicle charging station, the computer program product comprising:
a tangible storage medium readable by a processing circuit and storing instructions for execution by the processing circuit for performing a method comprising:
receiving an electrical power request from a consumer to provide electrical power to a vehicle;
initiating providing the electrical power to the vehicle in response to the electrical power request;
receiving a purchase request from the consumer to purchase an item other than electrical power;
receiving a specified method of payment for the item from the consumer;
completing the purchase using the specified method of payment; and
notifying the consumer that the purchase has been completed, the notifying in response to the completing.

47. The computer program product of claim 46, wherein the method further comprises:
receiving a status notification request;
receiving a contact method from the consumer;
periodically providing status information to the consumer via the contact method.

48. The computer program product of claim 46, wherein the method of payment comprises a coupon.

49. The computer program product of claim 46, wherein the method further comprises outputting a coupon via the user interface.

50. The computer program product of claim 46, wherein a source of the electrical power includes an electrical grid.

51. The computer program product of claim 46, wherein a source of the electrical power includes an energy storage system.

52. The computer program product of claim 46, wherein a source of the electrical power includes an other vehicle.

53. The computer program product of claim 46, wherein the item is purchased from a seller, and the method further comprises outputting a receipt of the purchase to the consumer, wherein the consumer presents the receipt to the seller in return for the item.

54. The computer program product of claim 46, wherein the receipt is a paper receipt.

55. The computer program product of claim 46, wherein the receipt is electronic.
